(19) United States
(12) Patent Application Publication
(10) Pub. No.: US 2007/0214431 A1
(43) Pub. Date: Sep. 13, 2007

(54) Smart gadget resizing

(75) Inventors: Louis Amadio, Sammamish, WA (US); David Streams, Sammamish, WA (US)

Correspondence Address: BANNER & WITCOFF, LTD.;ATTORNEYS FOR CLIENT NOS. 003797 & 013797, 1100 13th STREET, N.W., SUITE 1200, WASHINGTON, DC, 20005-4051, US

(73) Assignee: Microsoft Corporation, Redmond, WA (US)

(21) Appl. No.: 11/369,767

(22) Filed: Mar. 8, 2006

(51) Int. Cl. G06F 3/00; G06F 9/00

(52) U.S. Cl. 715/788

(57) ABSTRACT

A system and method is provided for displaying dynamic information in a dynamic information element in a designated area on a display and resizing the dynamic information element in the designated area based on resizing of the designated area. A command to resize the designated area on the display may be received. Based on the size of the resized designated area, the dynamic information element displayed within the resized designated area on the display is resized.

### BACKGROUND

Computer users are typically conflicted in their need for information on their computers. The typical user desires information to be displayed in a convenient manner on a display and that the information is up-to-date. At the same time, the space on a computer display over which information may be displayed is limited. Because information being displayed on a computer occupies space on the computer display, as the amount of information to be displayed increases, an increasing amount of space is consumed on the display, and a user must typically select certain information to display while forgoing other information. Thus, information is displayed to a user in an inefficient manner such that the information is inaccessible or the information may take up an excessive amount of space on the display. If the information takes up too much space on the display, the use of the display for other purposes (e.g., display of other information) is impaired accordingly.

A user is often required to close or quit windows to free up space on the display when the amount of information increases. However, when information is discontinued in this manner, the user may no longer have convenient access to the information such that if the user desires the information at a later time, the user must access the information and display the information on the display again. This can be inconvenient and frustrating to the user.

In addition, data or information may be displayed in a particular location on a display. For example, a user interface may be displayed in a predetermined area on a display. However, if a user wishes to decrease the size of the predetermined area on the display, the information provided in the predetermined area may no longer be available to the user if the size of the predetermined area is decreased to a size that precludes display of the information.

### SUMMARY

According to an illustrative aspect, a method and system provides information in a web page on a computer desktop. The information in the web page can include a location or address to files or scripts associated with desired information. The location or address can be represented on the web page as a representation of the location or address.

In one example, a method is provided for resizing a dynamic information element on a display. The dynamic information element may contain or display dynamic information that may change periodically or be updated. The dynamic information element may be contained in a designated area on the display such that resizing of the dynamic information element is based on resizing of the designated area.

In another example, a system is provided for determining and displaying a resized dynamic information element. The dynamic information element may be displayed in a designated area on the display and may be resized based on resizing of the designated area.

In another example, a computer-readable medium is provided having instructions for resizing a dynamic information element in a designated area on a display. The resizing of the dynamic information element may be based on resizing of the designated area.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example of a system for implementing various features which includes a general purpose computing device in the form of a computer.

FIGS. 2A-2E illustrate examples of displays of dynamic information according to some illustrative aspects of the invention.

FIG. 3 illustrates an example of a desktop display that displays a plurality of dynamic information elements according to at least one illustrative aspect of the invention.

FIG. 4 illustrates another example of a display containing dynamic information according to at least one illustrative aspect of the invention.

FIG. 5 illustrates the example of FIG. 4 in which the size of a designated area on a display is decreased according to at least one illustrative aspect of the invention.

FIG. 6 illustrates the example of FIG. 4 in which the size of a designated area on a display is increased according to at least one illustrative aspect of the invention.

FIG. 7 illustrates another example of FIG. 4 in which the size of a designated area on a display is increased according to at least one illustrative aspect of the invention.

FIG. 8 illustrates an example of dynamic information elements increasing in size up to a maximum size according to at least one illustrative aspect of the invention.

FIGS. 9A and 9B illustrate an example of changing the size of designated area and dynamic information elements in the designated area where the size of the dynamic information elements changes at discrete sizes according to at least one illustrative aspect of the invention.

FIG. 10 illustrates an example changing the size of at least one of a dynamic information element in the designated area according to at least one illustrative aspect of the invention.

FIG. 11 illustrates another example of offsetting a dynamic information element in a designated area responsive to a change in a dimension of the designated area according to at least one illustrative aspect of the invention.

FIG. 12 is a block diagram illustrating an example of a system for changing the size of the designated area and dynamic information elements on a display according to at least one illustrative aspect of the invention.

FIG. 13 is a flowchart illustrating an example of a method in which a dynamic information element is resized based on resizing of a designated area containing the dynamic information element according to at least one illustrative aspect of the invention.

FIG. 14 illustrates an example of applying a scaling factor to resize a dynamic information element in a designated area according to at least one illustrative aspect of the invention.

FIG. 15 is a flowchart illustrating an example of resizing and/or offsetting a dynamic information element in a designated area based on resizing, reshaping or change in position of the designated area according to at least one illustrative aspect of the invention.

### DETAILED DESCRIPTION

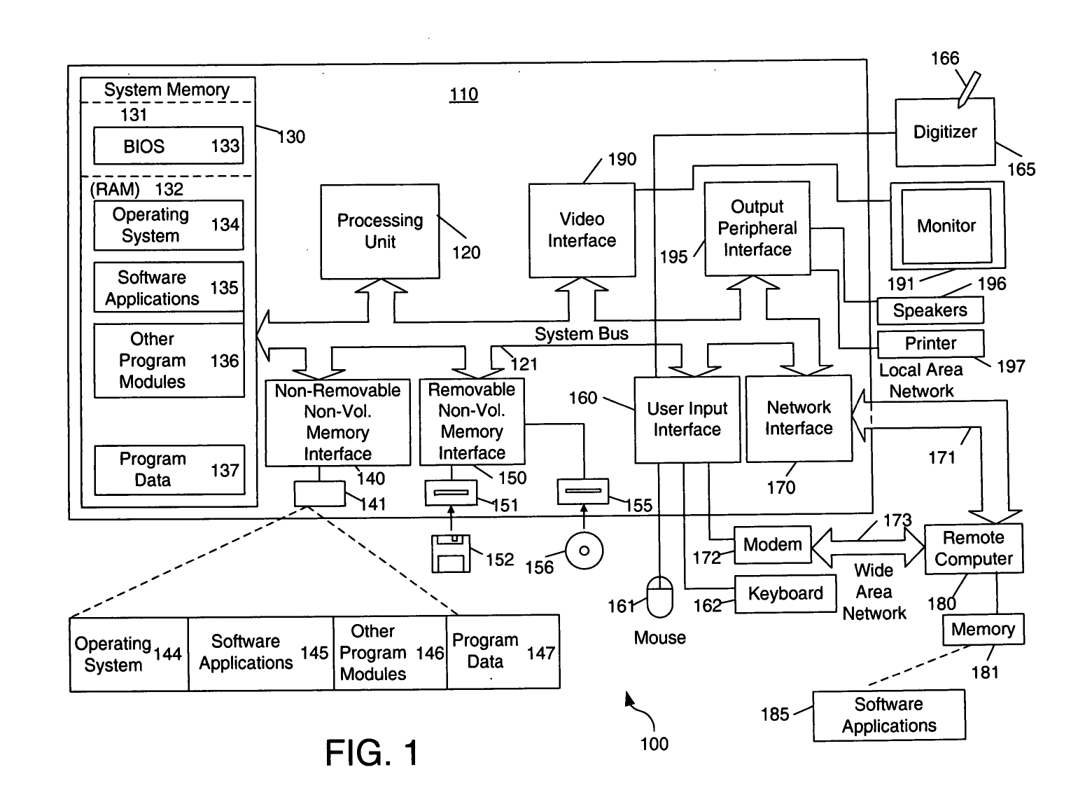

Examples provided herein may be implemented in a variety of operating environments. FIG. 1 illustrates an example of a suitable operating environment 100 in which aspects may be implemented. The operating environment 100 is only one example of a suitable operating environment and is not intended to suggest any limitation as to the scope of use or functionality of the invention. Other well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

FIG. 1 illustrates an example of one suitable computing system environment 100. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Various aspects are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

With reference to FIG. 1, an illustrative system includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media includes both volatile and nonvolatile media, removable and non-removable media. By way of example, and not limitation, computer readable media may comprise computer storage media and communication media and includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 196 and printer 197, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Aspects of the invention relate to a system and method for providing access to information in a computer system. In some aspects, information can be accessed by a user for display in an adjustable way and arranged in an orderly fashion on the display according to the user's preferences. Also, the information displayed can be resized.

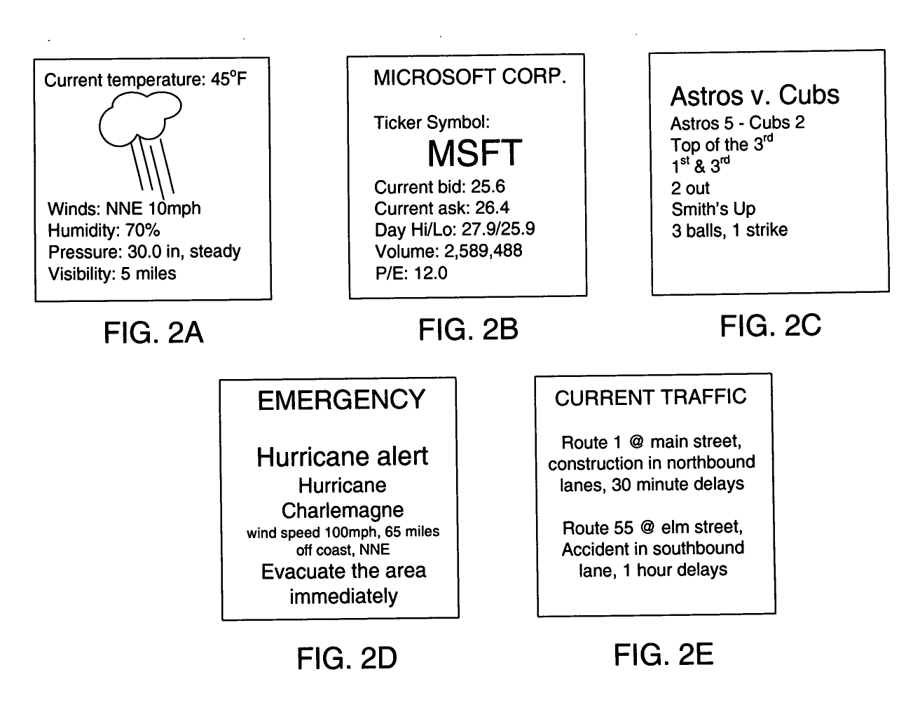

In one example, dynamic information may be displayed in a graphical element on a display. The graphical element is a dynamic information element which may alternately be referred to as a “gadget.” The dynamic information element may contain desired dynamic information which may include any information that may be updated periodically or in real-time (e.g., RSS). For example, the dynamic information may include weather reports for an area of interest. FIG. 2A illustrates an example of a display of dynamic weather information. The weather report may change periodically as weather forecasters gain more meteorological information or more accurate information of atmospheric conditions that may affect the weather. As new information is received or discovered, the weather forecast may change. In this example, the latest updated weather forecast may be displayed as the information is received. Hence, a user may observe a display of the weather forecast information as well as changes to the weather forecast information as they occur. The display may further include a graphical element to provide the weather information. Based on the up-to-date information displayed, the user may respond accordingly. For example, a user may receiving dynamic information of severe weather conditions and may respond by deciding to stay indoors.

In another example, dynamic information displayed to a user may include stock or commodity quote information. FIG. 2B illustrates an example of the display of dynamic stock quote information. Throughout the course of a day of active trading or in after hours trading, the price of a given stock may change. At any given moment in the day, a user may wish to know the current price of a stock, for example, to decide if he/she wishes to purchase the stock and to decide the quantity to purchase. When the stock quote information is provided as a static display, the user may not know if the displayed stock quote is current or if the price has changed since the stock quote was first displayed. Hence, the user may act inappropriately based on an erroneous or out-of-date stock quote because of the erroneous assumption that the statically displayed stock quote was up-to-date. However, in this example, the stock quote information displayed is dynamic information such that the display of the information is updated as the information changes. In addition, the display may include a graphic such as a graph or chart showing various trends. Thus, whenever the user wishes to know the price of a stock at a given time, the user need only observe the corresponding information displayed, which will be the most currently available information.

In another example, sports scores or other information pertaining to a sporting event or events may be displayed as dynamic information. FIG. 2C illustrates an example of a dynamic display of information pertaining to a sporting event. If a sporting event is ongoing, the score may change depending on the stage of the competition. A user may wish to know the current score of the game or other ongoing information pertaining to the event to keep abreast of the developments of the game. In this example, the dynamic information is displayed such that as the score or other status of the game changes, the displayed information also changes accordingly to provide the updated information. For example, if one team scores a point in the competition, the display will then display the revised score in which the team scoring the point has an additional point. In addition, the display may include a graphic for providing a pictographic indication of the status of the game. Thus, a user can be assured that the dynamic information provided (in this case, the score of the game) is up-to-date.

The dynamic information may also contain information pertaining to an emergency status in a particular area. For example, if a threat of a tornado, a severe thunderstorm, or any natural disaster is expected, the dynamic information displayed may reflect that threat. FIG. 2D illustrates an example of the display of dynamic information pertaining to an emergency status. The display may include warning information to a user or users. As the threat increase, the display may indicate the rising threat assessment as it occurs in real time. Also, the display may include a graphic illustrating the current conditions of the threat. Thus, a user may be informed with up-to-the-minute information in a situation that is rapidly changing. This enables the user to take appropriate action based on the current situation rather than relying on old or outdated information.

In another example, the dynamic information may include traffic information. At different times of the day or night, traffic patterns may change dramatically. For example, traffic patterns during rush hour may be markedly different than traffic patterns during off-peak travel times. Also, accidents may occur unexpectedly to affect the traffic flow. Dynamic traffic information may be provided to a user such that the user may be informed of the latest traffic conditions. The display may also include a graphic or map showing relevant and current traffic conditions of interest. FIG. 2E illustrates an example of the display of dynamic traffic condition information. In this example, the displayed dynamic traffic condition information may include information on the level of use of the roads or of specific streets, the existence of any accidents or sites of road construction, for example, that may cause traffic jams, or alternate routes available. Because the information provided is dynamic, the user can be assured that the displayed information is up-to-date and accurate.

Each of the dynamic information elements may be displayed within a delineated area on a display. As the examples in FIGS. 2A-2E illustrate, the information may be displayed within a shape that may be delineated by a border. In these examples, the shape is a square; however, any shape may be used. For example, dynamic information may be displayed within a circle, rectangle, triangle, irregularly shaped structure, etc. These are merely examples of dynamic information that may be provided and are not intended to be limiting or exhaustive. The delineated area may be circumscribed by a border, such as a solid line, dotted line, dashed line, or color or pattern change, or may not be circumscribed by a delimiting element at all.

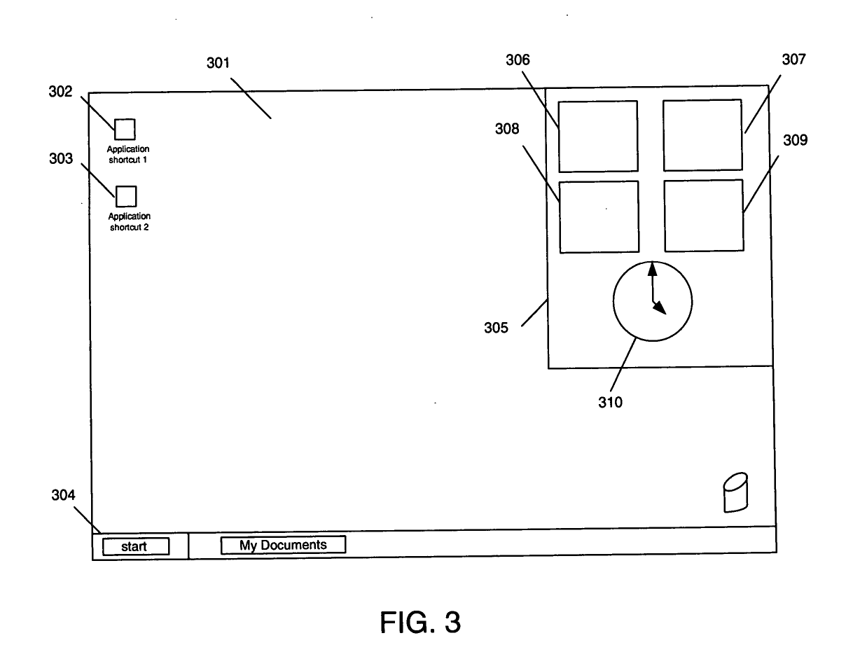

In another example, multiple types of dynamic information may be displayed in an organized manner. FIG. 3 illustrates an example of a desktop display that displays multiple dynamic information elements, each containing a display of dynamic information. In this example, each portion of dynamic information is displayed in a delineated area on the display. As FIG. 3 illustrates, a computer desktop 301 contains a taskbar 304 and various icons (302, 303) corresponding to applications stored or running on a computer. In addition, the desktop 301 also contains a predetermined or designated area 305 that contains displays of dynamic information elements (306, 307, 308, 309, and 310) containing dynamic information. The dynamic information elements (306-310) may include any desired information that may change periodically or be updated. In this example, the designated area 305 is illustrated in the upper right corner of the desktop 301; however, any convenient location on the desktop 301 may be used as the designated area 305. Additionally, in this example, the designated area 305 is demarcated on the desktop 301 by a graphic. In this case, the graphic demarcating the designated area 305 on the desktop 301 is a solid line. However, any desired graphic may be used such as a dotted line, a dashed line, pictures, colors, patterns, or shapes (e.g., circles, squares, etc.). Alternatively, no visible demarcation may be used to demarcate the designated area 305 on the desktop 301 (e.g., an “invisible line” may be used).

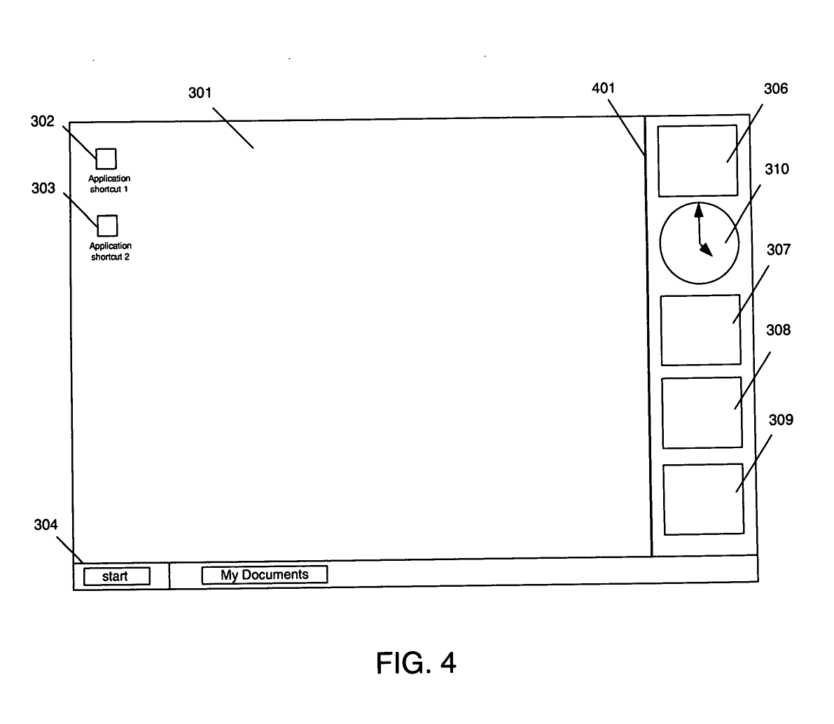

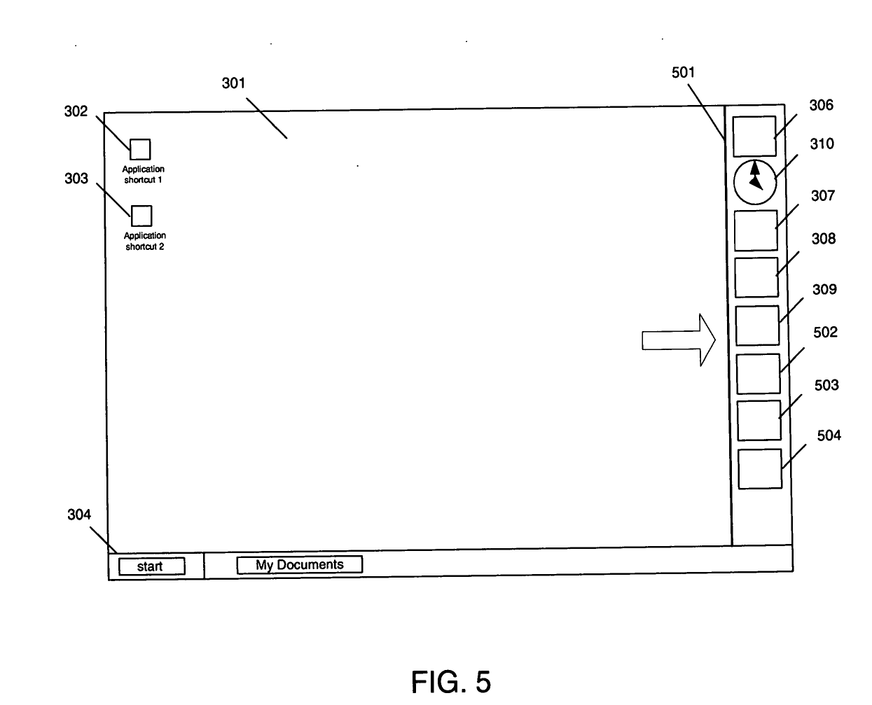

FIG. 4 illustrates another example of a display containing dynamic information. In this example, the dynamic information elements (306-310) are displayed in a predetermined or designated area 401 on the desktop 301 which is demarcated by a solid line. In this case, the designated area 401 is a sidebar that traverses the right vertical side of the desktop 301. The designated area 401 in this example (i.e., the sidebar) provides a location on the desktop 301 in which dynamic information may be presented to a user in a convenient and organized manner (i.e., within dynamic information elements). The dynamic information within each of the dynamic information elements (306-310) may be updated and changed in real-time as new information is received or new events occur warranting updating as described herein.

In an example of one aspect, the dynamic information elements (306-310) within a designated area 305 may be resized within the designated area as necessary. For example, a user may display dynamic information in a designated area on a desktop but may also desire to increase the size of the desktop space for uses other than displaying the dynamic information elements. The user may wish to decrease the size of the designated area to provide the additional desktop space. In this example, a change in the size of the designated area may include a corresponding change in size of dynamic information elements within the designated area. Also, a change in a dimension of a dynamic information element in a designated area may be responsive to a change in a corresponding dimension of the designated area. For example, a user may wish to decrease a width of the designated area. As the width of the designated area is decreased, a width of a dynamic information element within the designated area may also decrease independently of other dimensions of the dynamic information element.

As one example, the width of the dynamic information element may decrease in response to a decrease in the width of the designated area while the length of the dynamic information element decreases, increases or remains constant. Similarly, the length of the dynamic information element may change independently of changes in width of the dynamic information element. For example, if the length of the dynamic information element decreases responsive to a change in a dimension of the designated area, the width of the dynamic information element may increase, decrease or remain the same.

In another example, the area or size of the dynamic information element may remain substantially the same in response to changes in a dimension or changes in size of the designated area. For example, a decrease in the width of the designated area may result in a decrease in the width of the dynamic information element and a corresponding increase in the length of the dynamic information element. The decrease in width and increase in length of the dynamic information element may result in an overall increase or decrease in the area or size of the dynamic information element. Alternatively, the decrease in width and increase in length of the dynamic information element may cause the area or size of the dynamic information element to remain substantially the same.

In another example, a change in a dimension of the designated area may result in a change in an offset of a dynamic information element. The dynamic information element may change position within the designated area responsive to the change in a size of a dimension of the designated area. In one example, the width of the designated area may be decreased. In response to the decrease in the width of the designated area, a dynamic information element may be displaced in the designated area and displayed in a different location within the designated area.

In another example, the designated area contains multiple dynamic information elements and the width of the designated area is decreased. The width of a first dynamic information element within the designated area may decrease and the length of the first dynamic information element may increase in response to the decrease in width of the designated area or in response to the change in the dimension of the designated area. As the length of the first dynamic information element increases, a second dynamic information element in the designated area may be displaced by the resized first dynamic information element. For example, the increase in length of the first dynamic information element may result in moving the second dynamic information element in the designated area. Thus, a dynamic information element may become offset in the designated area by an amount based on resizing of the designated area.

In another example, a change in a dimension of the designated area may cause a change in positioning or offsetting of a dynamic information element in the designated area. In this example, a designated area may contain at least one dynamic information element at a location in the designated area. A dimension of the designated area may be changed—such as a width of the designated area may be changed (e.g., increased or decreased). In one example, the width of the designated area in increased. Responsive to the increase in width of the designated area, the at least one dynamic information element may shift position within the designated area or may be offset from a current location in the designated area. Alternatively, the at least one dynamic information element may shift position such that the dynamic information element is moved out of the designated area to an alternate location on the display responsive to the change in the dimension of the designated area.

Also, in another example, the designated area may contain a plurality of dynamic information element. A change in a dimension of the designated area may cause at least one of the dynamic information elements in the plurality of dynamic information elements to shift within the designated area to another location and another dynamic information element to resize independently of the shifting or offsetting of the other dynamic information elements. For example, a first dynamic information element may be resized responsive to a change in a dimension of the designated area while a second dynamic information element may be shifted or offset within the designated area responsive to the change in the dimension of the designated area but independently of the resizing of the first dynamic information element. Alternatively, either the first dynamic information element or the second dynamic information element in this example may be shifted or offset out of the designated area to another location on the display responsive to the change in dimension of the designated area. For example, either the first, second or any other dynamic information element in the designated area, responsive to a change in a dimension of the designated area may be relocated to the desktop or may be relocated to an overflow area of the designated area.

FIG. 5 illustrates one example in which a designated area (e.g., a sidebar) containing dynamic information elements displayed on a display is resized. A desktop 301 as illustrated in FIGS. 3-5 may contain or display a designated area (401, 501) that may contain at least one dynamic information element for displaying dynamic information as described. In FIG. 4, the designated area 401 occupies a space on the desktop 301. The space occupied by the designated area 401 on the desktop 301 may be changed. For example, a user may drag an edge of the designated area 401 to the right to decrease the size of the designated area 401. Alternatively, the user may drag the edge of the designated area 401 to the left to increase the size of the designated area. In FIG. 5, the edge of the designated area 401 is dragged to the right to decrease the size of the space occupied by the designated area 401 on the desktop 301 such that the new space occupied by the designated area (501 in FIG. 5) is smaller than the prior space occupied by the designated area (401 in FIG. 4). As the example of FIG. 5 illustrates, as the size of the space occupied by the designated area 501 on the desktop 301 decreases, the size of the dynamic information elements (301-310) also decreases accordingly. Also, as the size of the dynamic information elements (301-310) decreases, additional space may be available in the designated area 501 such that additional dynamic information elements (502, 503, and 504) may be displayed in the sidebar 501 as illustrated in this example. In this way, as the dimensions of the designated area 501 decrease, the dimensions of the dynamic information elements in the sidebar 501 decrease accordingly such that information contained in each of the displayed dynamic information elements is maintained after the size or dimensions of the designated area 501 is adjusted.

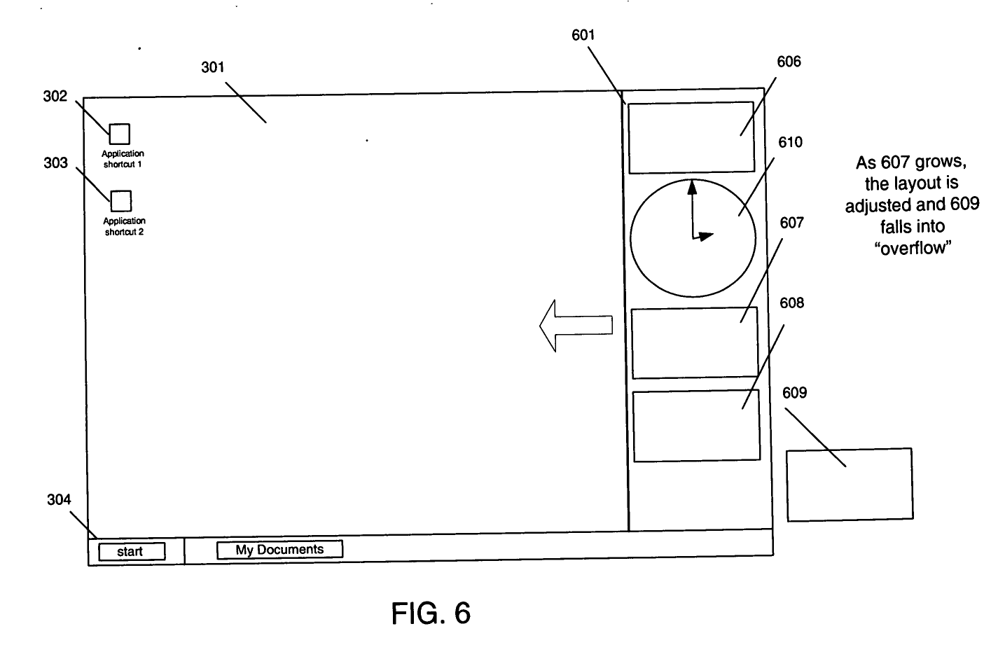

In another example, the size of a designated area containing or displaying one or more dynamic information elements that provide desired dynamic information on a desktop can be increased. FIG. 6 illustrates an example of increasing the size of a designated area on a desktop, in this case, a sidebar.

As the example of FIGS. 4 and 6 illustrate, a designated area (in this case, a sidebar 401) is displayed on a desktop 301 and provides dynamic information in dynamic information elements (e.g., 306-310). The designated area 401 in this example is delineated by a solid line and occupies an area on the desktop. The size of the designated area 401 may be increased such that the designated area 401 may occupy a larger area on the desktop 301. As illustrated, the left edge of the designated area 401 may be dragged to the left to increase the size of the designated area 401. FIG. 6 illustrates the desktop 301 containing a designated area 601 which is an enlarged designated area 401. As the size of the designated area 401 increases, the dynamic information elements (306-310) also increase in size. In this way, additional dynamic information may be displayed in each enlarged dynamic information element (606-610).

The dynamic information elements (606-610) in the designated area 601 may increase size through an increase in any one dimension or combination of dimensions. In the example illustrated in FIG. 6, the width of each of the dynamic information elements (606-610) increases in proportion to the increase in size of the designated area 601. However, the size of the dynamic information elements (606-610) may increase by an increase in length or a combination of width and length as well. As also illustrated in the example of FIG. 6, a length of a dynamic information element may increase such that at least one dynamic information element may not fit in the resized designated area. If this is the case, a dynamic information element may be removed from the designated area to an overflow area. In this example, dynamic information element 609 has been removed from the designated area and has been moved to overflow because dynamic information element 609 does not fit in the designated area after resizing of the designated area and resizing of the dynamic information elements (606, 607, 608, 609, and/or 610).

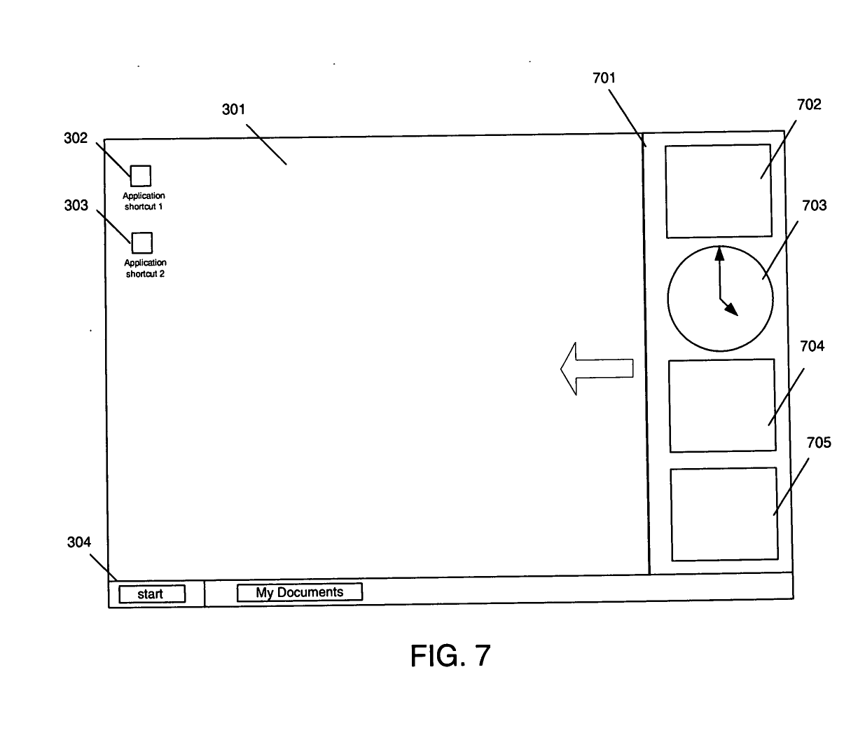

FIG. 7 illustrates an example in which the size of each of the dynamic information elements increases in size at a fixed aspect ratio such that ratio of the length to the width of each of the dynamic information elements remains substantially the same while the size of each of the dynamic information element increases in proportion to the increase in size of the designated area 701. The left edge of the designated area 401 illustrated in FIG. 4 may be dragged to the left such that the size of the designated area 401 increases as illustrated by the designated area 701 in FIG. 7. The dynamic information elements (306-310) within the designated area 401 may also increase in size as the size of the designated area 401 is increased. As shown in the example of FIG. 7, the dynamic information elements increase in size proportionately to the increase in size of the designated area such that the larger designated area 701 contains larger dynamic information elements (702-705). Also in this example, the dynamic information elements (702-705) increase in size while maintaining substantially the same aspect ratio of length to width.

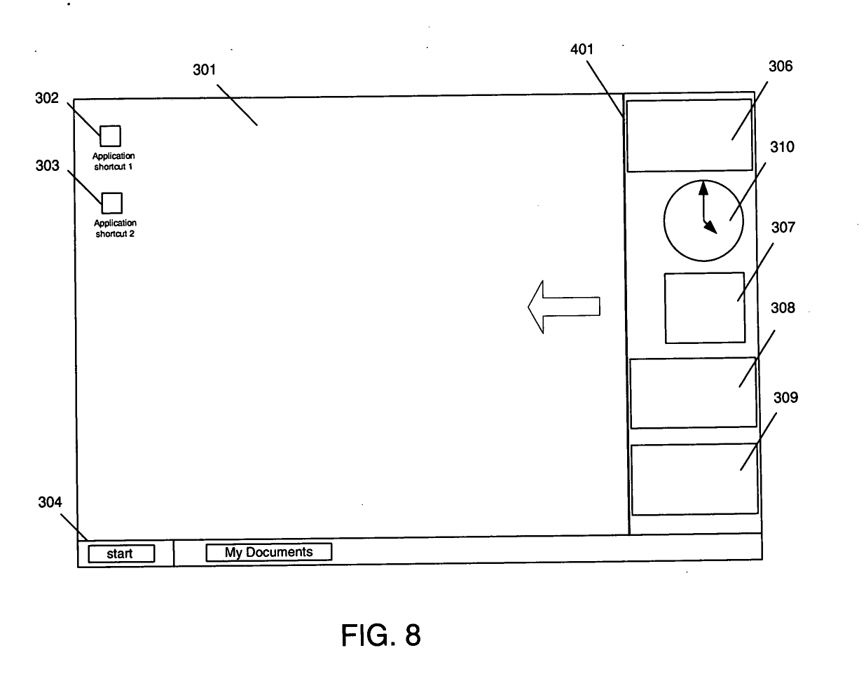

It will be appreciated that the function of increasing or decreasing the size of the dynamic information elements or a dimension of the dynamic information elements does not have to be proportionate to the respective increase or decrease in size or dimension of the designated area. For example, the size/dimension increase of the dynamic information element may be non-linear with respect to the designated area for a portion of the increase. If a dynamic information element is to be removed or moved partially out of view if the size increase were to continue, the increase of the one or more of the dynamic information elements may behave in another manner to prevent a portion of the dynamic information element from being partially or totally removed from the display. For example, with an increase in the size of the designated area, the size of any one of the dynamic information elements may remain at a particular size as the size of the designated area continues to increase. In one example, each of dynamic information elements in the designated area increase in size as the size of the designated area increases. When the designated area exceeds a particular size in which additional increases in the size of the dynamic information elements contained in the designated area would result in either removal or partial removal of any one of the dynamic information elements, at least one of the dynamic information elements may retain a current (e.g., maximum) size. Alternatively, a maximum size of a dynamic information element may be determined by user preferences, data supplier, developer, author, or predetermined such that a dynamic information element may be increased up to the maximum size at which point further increases in the designated area does not result in a further increase in the size of the dynamic information element beyond the maximum size. FIG. 8 illustrates an example of dynamic information elements increasing in size up to a maximum size. In this example, the size of a designated area 401 is increased. The designated area 401 includes dynamic information elements (306-310). As the size of the designated area 401 is increased (depicted by the arrow in FIG. 8), the size of the dynamic information elements 306, 308 and 309 increase. However, in this example, dynamic information elements 310 and 307 are at a maximum size. Therefore, as the size of the designated area 401 is increased, the size of dynamic information elements 310 and 307 are not further increased.

In another example, the size of the designated area may be decreased (e.g., by dragging a vertical side of a vertically oriented designated area) and dynamic information elements contained in the designated area may decrease in size to a minimum size. When the size of the designated area is further reduced, at least one dynamic information element in the designated area may retain a current (minimum) size with further decreases in the size of the designated area. In one example, the minimum size of the dynamic information element may prevent loss of usable or readable information within the dynamic information elements.

In another example, increases or decreases in the size of the designated area may result in corresponding increases or decreases in the size of the dynamic information elements in a continuous manner. For example, the size of the designated area may be changed within a range of values, e.g., by dragging a side of the designated area on a display. In the example illustrated in FIG. 4, a side of the designated area 401 may be dragged to the right to decrease the size of the designated area 401 and dragged to the left to increase the size of the designated area 401. In an example of increasing or decreasing the size of the dynamic information elements in a continuous manner, as the side of the designated area is dragged, the size of the dynamic information elements may change in real-time such that the size of the dynamic information elements increases or decreases with the corresponding increase or decrease in size of the designated area. In this example, the change in the size of the dynamic information elements in the designated area tracks the changes in the size of the designated area to provide a smooth appearance in the change in size of the dynamic information elements.

Alternatively, the size of the dynamic information elements may be changed in a non-continuous manner in which changes in the size of the designated area result in step-wise changes in size of the dynamic information elements contained in the designated area. For example, as the side of the designated area 401 of FIG. 1 is dragged to the left to increase the size of the designated area 401, the dynamic information elements within the designated area 401 may remain at their current sizes. When the size of the designated area 401 reaches a threshold value (e.g., increases beyond a threshold value), the size of the dynamic information elements may increase to a next (larger) size level. Likewise, if the side of the designated area 401 (the example of FIG. 4) is moved to the right to decrease the size of the designated area 401, the dynamic information elements within the designated area 401 may retain their current sizes until a certain size of the designated area 401 is achieved (i.e., a threshold size). After the threshold size is reached, the dynamic information elements in the designated area 401 may decrease in size such that each of the dynamic information elements may fit within the designated area 401. These processes may be repeated such that further increases or decreases in the designated area results in a further stepwise increase or decrease in size of the dynamic information elements. Hence, in this example, the size of an individual dynamic information element may only change at discrete sizes of the designated area as described below rather than continuously when the size of the designated area is increased or decreased.

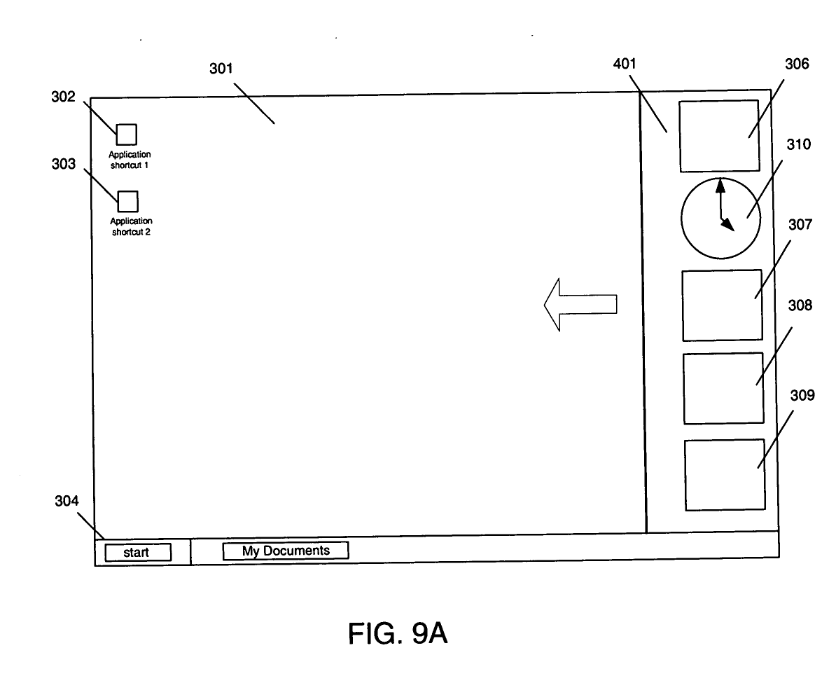

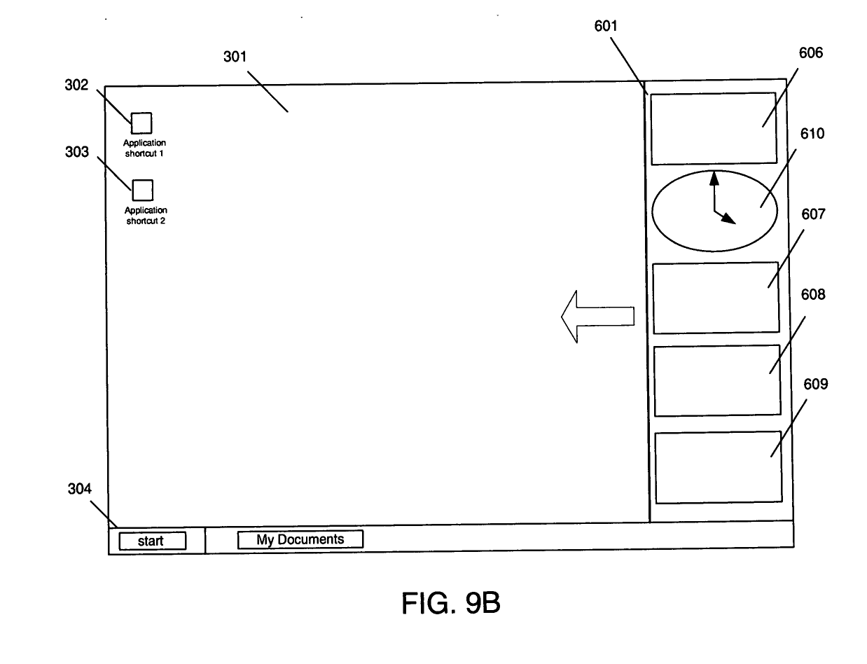

FIGS. 9A and 9B illustrate an example of changing the size of designated area and dynamic information elements in the designated area where the size of the dynamic information elements changes at discrete sizes (e.g., in a stepwise fashion) with changes in the size of the designated area. In this example, the size of the designated area 401 is increased by dragging a side of the designated area 401. As FIG. 9A illustrates, the size of designated area 401 increases, however, the size of the dynamic information elements 306-310 do not increase in a continuous fashion with a corresponding increase in the size of the designated area 401. FIG. 9B illustrates a further increase in the size of the designated area beyond a predetermined threshold value. When the size of the designated area is increased beyond this point, the dynamic information elements (606-610) increase to a larger size in response. The change in size of the dynamic information elements is discrete such that the size changes from a first (smaller) size to a second (larger) size in a stepwise fashion (i.e., does not assume an intermediate size between the first and second size during the change in size from the first size to the second size).

In yet another example, the designated area may include multiple dynamic information elements, each of which may change in size at a different rate or proportion in response to a change in the size of the designated area. For example, as the size of the designated area containing multiple dynamic information elements is increased or decreased, each of the dynamic information elements may increase or decrease at a non-uniform proportion such that each of the dynamic information elements may be increasing or decreasing at a rate/proportion specific to the specific dynamic information element. For example, if one dynamic information element provides news information and another dynamic information element provides the local time, as the designated area containing the two dynamic information elements is increased or decreased, one dynamic information element may increase or decrease at a first rate or proportion which the other dynamic information element may increase or decrease at a second rate or proportion. In one example, the size of the designated area is decreased and each of the dynamic information element containing news information and the dynamic information element containing time information decreases. However, the dynamic news information element may contain more information (e.g., more text or graphics) than the dynamic time information element such that the dynamic time information element may withstand a larger decrease in size than the dynamic news information element. For example, the dynamic news information element may contain additional text such that if the dynamic news information element is decreased in size beyond a certain size, the text and information provided within the dynamic news information element is no longer easily viewed or obtained. In this case, the size of the dynamic news information element may decrease at a lower rate or proportion as compared to the dynamic time information element. Also, the maximum or minimum sizes of each of the dynamic information elements may be different for any number of different dynamic information elements in the designated area. In this example, the minimum size of the dynamic news information element may be larger than the minimum size of the dynamic time information element.

In this example, each dynamic information element may have a corresponding parameter indicating a type of information contained in the dynamic information element. Resizing of a dynamic information element may be based on the type parameter associated with the dynamic information element. As one example to illustrate, if a first dynamic information element contains a type parameter indicating that the first dynamic information element contains a first type of dynamic information that corresponds to a first minimum size of the dynamic information element, then resizing of the first dynamic information element may be limited to the first minimum size when a dimension of the designated area containing the first dynamic information element is decreased. Likewise, a maximum size may be provided associated with a dynamic information element.

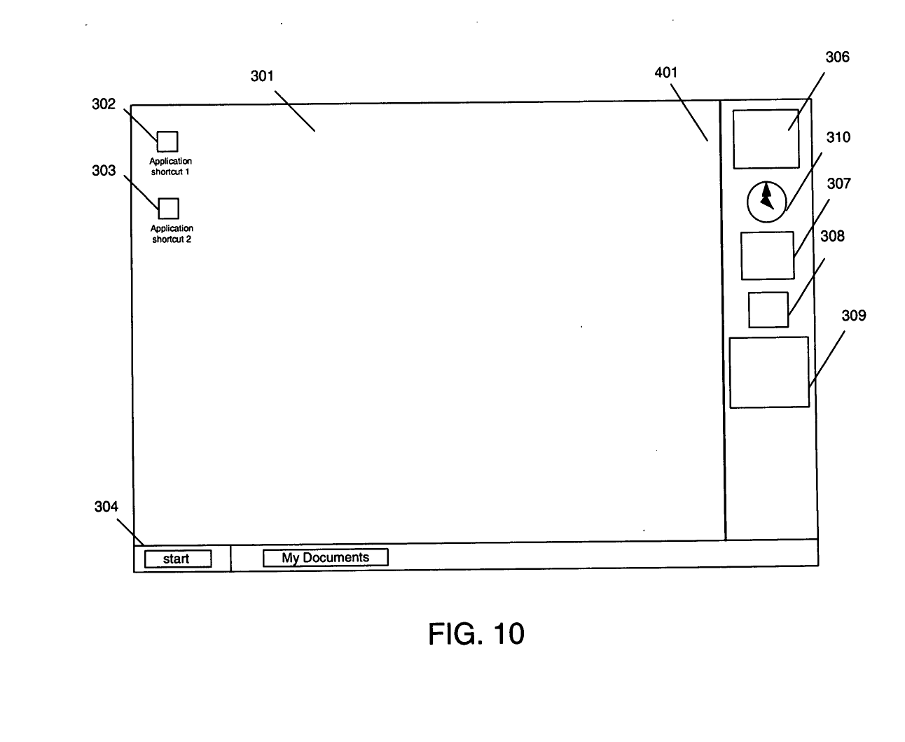

FIG. 10 illustrates an example of changing the size of a designated area and changing the size of at least one of a dynamic information element in the designated area. In this example, the size of the designated area 401 has been changed which may result in a change in at least one of the dynamic information elements (306-310) within the designated area. However, in this example, any one of the dynamic information elements may change in size independently from any one of the other dynamic information elements such that the different dynamic information elements may increase or decrease by a percentage, proportion, or amount that is different from any of the other dynamic information elements in the designated area. As FIG. 10 illustrates, the dynamic information elements (306-310) in the designated area 401 are of different sizes and proportions and as the size of the designated area 401 is changed, the different dynamic information elements 306-310, changes by a different proportion or amount.

The rate or proportion at which any one dynamic information element in the designated area is increased or decreased may depend, for example on the content of the dynamic information element. An algorithm may be provided for determining the content of a dynamic information element and based on the determined content, the rate or proportion of increase or decrease of the dynamic information element may be applied to the dynamic information element. For example, the rate or proportion of increase or decrease of the dynamic element may be based on type of content, amount of content, variation in content, text:graphic ratio of the content, content priority (e.g., a priority value assigned to the content, for example, by a user or a data provider), etc. Also, maximum and/or minimum sizes for each of the dynamic information elements may be similarly determined.

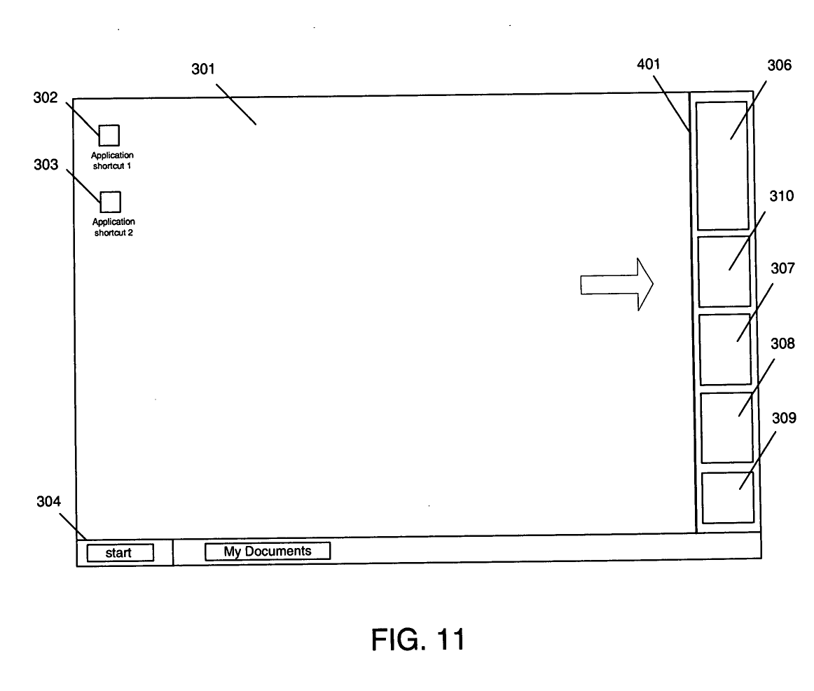

FIG. 11 illustrates another example of offsetting a dynamic information element in a designated area responsive to a change in a dimension of the designated area. As FIG. 11 illustrates, the width of the designated area 401 of FIG. 4 is decreased (as illustrated by the arrow in FIG. 11). The decrease in the width of the designated area 401 causes a decrease in the width of dynamic information element 306. Also in response to the decrease in the width of the designated area 401, the length of the dynamic information element 306 is increased. The increase in length of dynamic information element 306 results in an offsetting of dynamic information elements 310, 307, 308 and 309 which, in this example, are offset by an amount about equal to the increase in length of dynamic information element 306. Also, in the example illustrated in FIG. 11, the width of each of dynamic information elements 310, 307, and 308 is decreased in response to the decrease in width of the designated area 401. However, dynamic information element 309 maintains about the same length as prior to the adjustment of width of the designated area. Thus, dynamic information elements 310, 307 and 308 illustrate a change in a dimension of a dynamic information element (i.e., decrease in width) responsive to a change in a dimension of the designated area (i.e., decrease in width) while another dimension of the dynamic information element is maintained (i.e., length). Dynamic information element 309 illustrates a change in a dimension of a dynamic information element (i.e., decrease in width) responsive to a change in a dimension of the designated area (i.e., decrease in width) while another dimension of the dynamic information element is also changed (i.e., decrease in length). Dynamic information element 306 illustrates a change in a dimension of a dynamic information element (decrease in width) responsive to a change in a dimension of the designated area (i.e., decrease in width) while another dimension of the dynamic information element is changed in a different or independent manner (i.e., increase in length). Also illustrated in the example of FIG. 11 is offsetting or repositioning of dynamic information elements in a designated area responsive to a change in a dimension of the designated area (i.e., dynamic information elements 310, 307, 308, and 309 are downwardly offset in the illustration of FIG. 11).

In another example, a system receives an input corresponding to a change in size of a designated area on a display containing dynamic information elements that display dynamic information. In this example, a dynamic information element in a designated area on a display may be resized based resizing of the designated area independent of the initial design of the dynamic information element. For example, the dynamic information element may be resized by a “world transform” in a Windows Presentation Framework, a “zoom factor,” or via a CSS property in HTML. Alternatively, resizing of the dynamic information element may be performed by selection of a size of the dynamic information element based on a size of the designated area. For example, a designer/author of the dynamic information element may provide multiple versions of the dynamic information element that vary by size. Each of the dynamic information elements may be substantially the same as the other dynamic information elements but for the size. In this example, a particular sized version of the dynamic information element may be selected based on the selected size of the designated area (or selected size of a dimension of the designated area) in which the dynamic information element is contained. For example, if a width of the designated area is 125 pixels, then a version of the dynamic information element up to approximately 125 pixels may be selected and displayed in the designated area. However, if the width of the designated area is 80 pixels, then a version of the dynamic information element up to approximately 80 pixels may be selected and displayed in the designated area (e.g., a version of the dynamic information element that is 125 pixels may not be selected in this case). Thus, versions of the dynamic information element that have a dimension that is larger than the corresponding dimension of the designated area are not selected for display in this example.

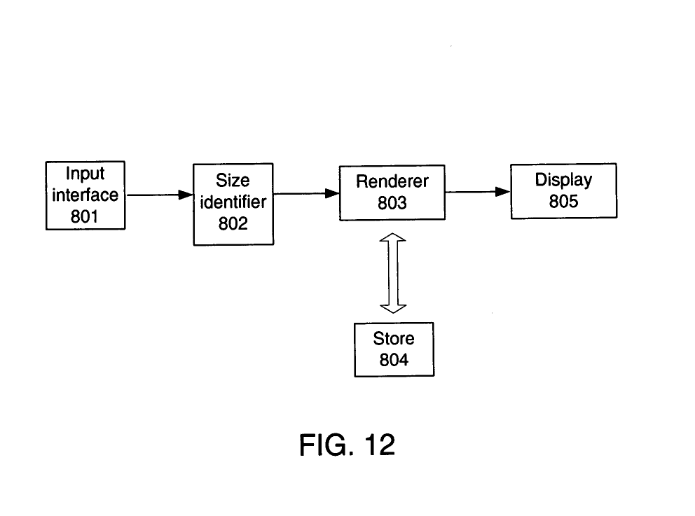

FIG. 12 is a block diagram illustrating an example of a system for changing the size of the designated area on a display and changing the size of dynamic information elements in the designated area accordingly. In this example, an input interface 801 receives an input. The input may include a command to change the size of the designated area on the display. In one example, the command is to decrease the size of the designated area. In another example, the command is to increase the size of the designated area. For example, a user may drag an edge of the designated area in a desired direction on a display to either increase or decrease the size of the designated area.

The input interface 801 may receive the input indicating the size change of the designated area and a size identifier 802 may determine the size of the resized designated area and provide the determined size to a renderer 803 in the display. The renderer 803 receives the determined size of the designated area and determines the corresponding size of a dynamic information element within the designated area. In this example, the dynamic information element object may be contained in a store 804 and may include different sizes of the dynamic information element object. For example, a developer may design a clock (as one example of a dynamic information element) to be a certain size for a designated area or sidebar that is 125 pixels in width. The designer/author may further provide additional clock elements of varying sizes and may store the clock elements of varying sizes in memory. When the size of the designated area containing the clock information element is altered, the clock at the certain size of the designated area may no longer fit in the designated area. As one specific example to illustrate, the designated area may be 125 pixels in width and the clock (designed by a developer) may be 115 pixels in diameter to fit within the designated area that is 125 pixels in width. When the size of the designated area is decreased to, e.g., 80 pixels, then the 115 pixel clock will no longer fit in the designated area. The store 804 in this example contains multiple instances of the clock object at different sizes, e.g., one clock object at 100 pixels, one at 95 pixels, one at 90 pixels, one at 80 pixels, one at 75 pixels, one at 70 pixels, one as 65 pixels, etc. When the size identifier 802 determines the size of the designated area is, e.g., 125 pixels, then the corresponding clock object at the proper size may be selected by the renderer 803 from the store 804 (e.g., 100 pixels in this example). As the size of the designated area decreases in this example to, e.g., 95 pixels, then the clock object that is 90 pixels or less in maximum dimension may be selected by the renderer 803 from the store 804. In one example, the largest clock object that fits within the designated area at the new size is selected. The corresponding object is then rendered in the renderer 803 and displayed (via display 805).

Thus, in this example, a developer/author may supply multiple layouts or images for multiple sizes of a dynamic information element where each different size of the dynamic information element corresponds to a size of a dimension of the designated area or a range of sizes of the designated area. As the dimension of the designated area changes, a corresponding size of the dynamic information element may be selected for display in the resized designated area based on the corresponding size of the dynamic information element size instance or size of the dimension of the dynamic information size instance.

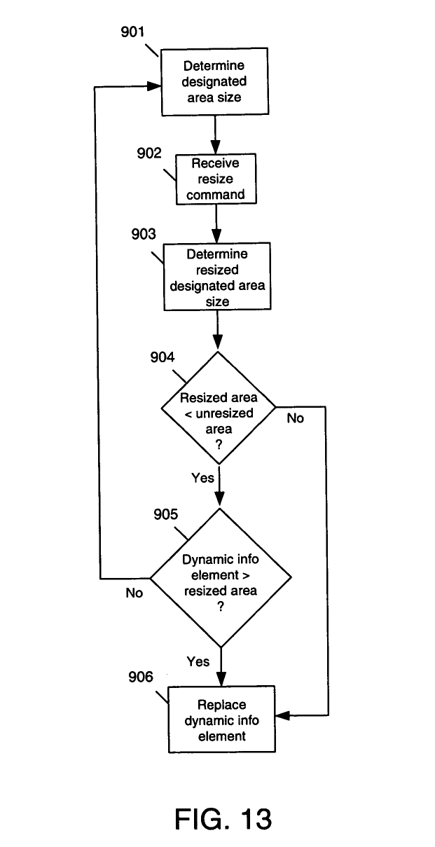

FIG. 13 is a flowchart illustrating an example of a method in which a dynamic information element is resized based on resizing of a designated area containing the dynamic information element. A designated area is displayed containing at least one dynamic information element providing dynamic information. In STEP 901, the size of the designated area is determined. The size of the designated area is determined relative to the size of the dynamic information element. Initially, the dynamic information element fits within the designated area. In STEP 902, a resize command is received for resizing the designated area. For example, a command may be received in STEP 902 for decreasing the size of the designated area. The size of the resized designated area is determined in STEP 903. This determined size of the resized designated area is compared to the size of the dynamic information element contained in the designated area in STEP 904. If the size of the resized designated area is smaller than the designated area not resized (the “YES” branch of STEP 904), then the size of the dynamic information element is compared to the size of the resized designated area (STEP 905). If a dimension of the dynamic information element is larger than a corresponding dimension of the resized designated area, then the dynamic information element may not fit within the designated area after the designated area is resized. For example, if the width of the dynamic information element is larger than the width of the resized designated area, then the dynamic information element no longer fits within the resized designated area. In this case (the “YES” branch of STEP 905), the dynamic information element is replaced with a corresponding dynamic information element of a different (smaller, in this example) size (STEP 906). For example, if the width of the resized designated area is 90 pixels but the width of the dynamic information element is 100 pixels, then if the dynamic information element is not resized, then a portion of the dynamic information element may be obscured. In this example, the 100 pixel dynamic information element may be replaced with a smaller sized (i.e., a resized) dynamic information element that has a smaller width than the designated area.

If the dynamic information element is still smaller than the resized designated area such that a dimension of the dynamic information element is still less than the corresponding dimension of the designated area, then resizing of the dynamic information element may not be necessary.

In another example, the designated area can be resized as described. However, the command to resize the designated area includes a command to increase the size of the designated area (the “NO” branch of STEP 904). In this case, the size of a dynamic information element contained within the designated area may be increased accordingly such that a dimension of the dynamic information element may be increased in proportion to the increase of the corresponding dimension of the designated area. In this example, the dynamic information element may be replaced with a corresponding resized dynamic information element (STEP 906). Replacing the dynamic information element may include receiving an appropriately sized (i.e., smaller than the designated area) dynamic information element in a renderer and displaying the received dynamic information element on a display.

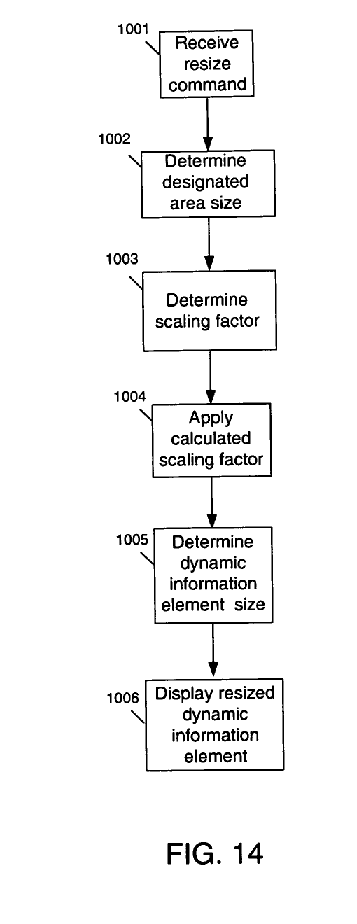

In another example, a dynamic information element in a designated area may be resized by applying a scaling factor. FIG. 14 illustrates an example of applying a scaling factor to resize a dynamic information element in a designated area. In this example, a designated area may be displayed including at least one dynamic information element providing dynamic information. The designated area may be resized, for example, after receiving a resize command (STEP 1001). Based on the resize command, the size of the resized designated area may be determined (STEP 1002) and compared to the size of the designated area prior to resizing to determine a scaling factor for the at least one dynamic information element (STEP 1003). The scaling factor may be derived from a ratio calculated to determine the proportion of the change of size of the designated area. For example, if the width of the designated area prior to resizing is 125 pixels and the width of the designated area after resizing is 100 pixels, then the ratio of the width of the designated area after resizing (100 pixels, in this example) to the width of the designated area prior to resizing (125 pixels, in this example) is 100/125=80%. Thus, in this example, the scaling factor is 80%.

The scaling factor may be applied to the dynamic information element (STEP 1004). For example, a dimension of the dynamic information element may be multiplied by the scaling factor to determine the resized dimension of the dynamic information element (STEP 1005). The resized dimension of the dynamic information element may thus be increased or decreased proportionately based on a corresponding increase or decrease in the corresponding dimension of the designated area. The resized dynamic information element may be displayed within the resized designated area (STEP 1006). Thus, in this example, resizing of the dynamic information elements may be performed independently of the developer/author by adjusting the dynamic information elements responsive to changes in the designated area. The size of a dimension or size of an area of a dynamic information element may be changed in a variety of ways. For example, resizing of the dynamic information element in this example may be accomplished using the “world transform” or “Zoom factor”. The method of resizing the dynamic information element may further depend on a specific technology used such as windows Presentation Framework or via the CSS (Cascading Style Sheets) property in HTML, to name a few.

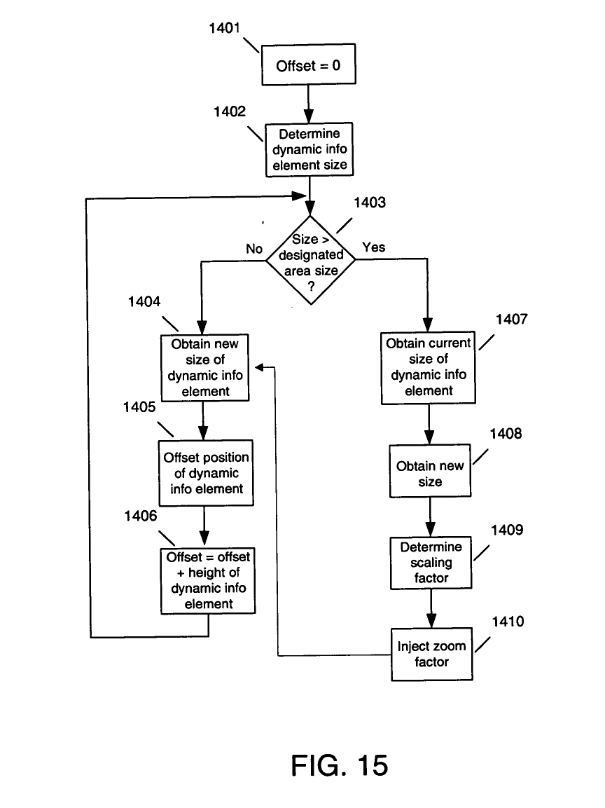

In another example, a designated area can be resized or the shape or position of the designated area may be changed. The dynamic information elements in the designated area may be arranged accordingly. FIG. 15 is a flowchart illustrating an example of resizing and/or offsetting a dynamic information element in a designated area based on resizing or reshaping of the designated area. In STEP 1401, an offset is initially set to “0” for each dynamic information element in the designated area. A resizing of the designated area or a dimension of the designated area may cause changes in the size of any of the dynamic information elements or a dimension of any of the dynamic information elements in the designated area.

In STEP 1402, the size of a dynamic information element or size of a dimension of the dynamic information element is determined. If the size of the dynamic information element is less than or equal to the size of the designated area or if a dimension of the dynamic information element is less than or equal to a corresponding dimension of the designated area (the “NO” branch of STEP 1403), then the new size of the dynamic information element is obtained (STEP 1404) and the dynamic information element is offset by the offset amount (STEP 1405). The offset of another dynamic information element may be determined based on the resizing of the resized dynamic information element. For example, if a first dynamic information element is resized such that a length of the first dynamic information element is increased, then the offset for a second dynamic information element may be determined by adding the increased length of the first dynamic information element to the previous offset applied to the first dynamic information element (in this case, zero). The offset for the second dynamic information element may thus be determined and applied to the second dynamic information element (STEP 1406). In addition, the size of the second dynamic information element or the size of a dimension of the second dynamic information element may be resized based on the resizing of the designated area. The process returns to STEP 1403 to compare the size of the second dynamic information element to the size of the designated area or the size of a dimension of the second dynamic information element with a size of a corresponding dimension of the designated area (STEP 1403).

When the size of a dynamic information element is greater than the size of the designated area (“YES” branch of STEP 1403), the current size (STEP 1407) and new size (STEP 1408) of the dynamic information element is obtained. A scaling factor is determined (STEP 1409) and a zoom factor, based on the scaling factor, is injected to adjust the size of the dynamic information element (STEP 1410). For example, the size of the dynamic information element may be compared to the size of the resized designated area or the size of a dimension of the dynamic information element may be compared to the size of a corresponding dimension of the designated area.

Based on the comparison, a scaling factor may be determined. In one example, a ratio is calculated between the size of the dynamic information element (or a dimension of the dynamic information element) and the size of the designated area (or a corresponding dimension of the designated area). The ratio may be applied to the size/dimension of the dynamic information element to determine the size of the resized dynamic information element (e.g., by multiplying the ratio by the corresponding size or dimension of the dynamic information element). After resizing of the dynamic information element (STEP 1410), the process continues at STEP 1404 where the new size of the dynamic information element is obtained and the offset position is determined (STEP 1405). The offset may be determined as described above.

It is understood that aspects of the present invention can take many forms and embodiments. The embodiments shown herein are intended to illustrate rather than to limit the invention, it being appreciated that variations may be made without departing from the spirit of the scope of the invention. Although illustrative embodiments of the invention have been shown and described, a wide range of modification, change and substitution is intended in the foregoing disclosure and in some instances some features of the present invention may be employed without a corresponding use of the other features. Accordingly, it is appropriate that the appended claims be construed broadly and in a manner consistent with the scope of the invention.

We claim:

1. In a computer system, a method of resizing a dynamic information element on a display, comprising:
displaying at least one dynamic information element in a designated area on the display;
resizing the designated area on the display;
resizing the at least one dynamic information element in the designated area based on the resizing of the designated area on the display.

2. The method of claim 1 wherein resizing the designated area comprises resizing a dimension of the designated area to obtain a resized dimension and resizing the at least one dynamic information element comprises resizing a first dimension of the at least one dynamic information element corresponding to the dimension of the designated area to obtain a resized first dimension.

3. The method of claim 2 wherein the step of resizing the at least one dynamic information element comprises:
determining a scaling factor;
multiplying the first dimension of the at least one dynamic information element by the scaling factor to obtain the resized first dimension,
wherein the first dimension of the at least one dynamic information element is greater than the resized dimension of the designated area.

4. The method of claim 3 wherein the step of determining a scaling factor comprises dividing the resized dimension of the designated area by the dimension.

5. The method of claim 3 wherein the step of resizing the at least one dynamic information element further comprises resizing a second dimension of the at least one dynamic information element responsive to the step of resizing the designated area to obtain a resized second dimension.

6. The method of claim 5 wherein the step of displaying at least one dynamic information element comprises displaying the at least one dynamic information element at a first location in the designated area and displaying a second dynamic information element at a second location in the designated area.

7. The method of claim 6 further comprising offsetting the second dynamic information element in the designated area by an offset amount based on resizing the designated area.

8. The method of claim 7 wherein the offset amount is about equal to a difference between a size of the second dimension and a size of the resized second dimension.

9. The method of claim 8 further comprising displaying the at least one dynamic information element containing the resized first dimension and displaying the second dynamic information element at a third location, the third location being offset from the second location by the offset amount.

10. The method of claim 1 further comprising storing the at least one dynamic information element at a plurality of predetermined sizes.

11. The method of claim 10 wherein the step of resizing the at least one dynamic information element comprises selecting the at least one dynamic information element at a predetermined size of the plurality of predetermined sizes based on resizing the designated area.

12. The method of claim 11 wherein the selecting comprises selecting the at least one dynamic information element at the predetermined size wherein a dimension of the at least one dynamic information element at the predetermined size is less than or equal to a corresponding dimension of the designated area.

13. The method of claim 11 wherein the at least one dynamic information element at each of the predetermined sizes in the plurality of predetermined sizes corresponds to at least one size of the designated area and wherein the selecting comprises selecting the at least one dynamic information element at a predetermined size based on the corresponding size of the resized designated area.

14. The method of claim 13 further comprising displaying the at least one dynamic information element at the selected predetermined size in the designated area.

15. The method of claim 1 wherein resizing the designated area comprises resizing a dimension of the designated area from a first size to a second size and wherein resizing the at least one dynamic information element comprises maintaining a size of a dimension of the at least one dynamic information element at a current size while resizing the designated area from the first size to the second size.

16. The method of claim 1 wherein displaying comprises displaying a plurality of dynamic information elements in the designated area and resizing the at least one dynamic information element comprises resizing a dimension of a first dynamic information element in the plurality of dynamic information elements by a first amount and resizing a dimension of a second dynamic information element in the plurality of dynamic information elements by a second amount, the first amount and the second amount being different.

17. The method of claim 16 wherein the first amount is non-zero and the second amount is zero.

18. The method of claim 16 further comprising determining the first amount based on a characteristic of the first dynamic information element and determining the second amount based on a characteristic of the second dynamic information element.

19. A system for displaying a resized dynamic information element comprising:
a display device for displaying a designated area on a display, the designated area including at least one dynamic information element for displaying dynamic information;
a size identifier for determining a size of the designated area on the display;
a renderer for resizing the at least one dynamic information element in the designated area based on the size of the designated area,
wherein the display device displays the resized at least one dynamic information element within the designated area.

20. A computer-readable medium having instructions stored thereon for performing the following steps:
receiving a resize command for resizing a designated area on a display, the designated area containing at least one dynamic information element for displaying dynamic information;
resizing the designated area responsive to the resize command from a first size to a second size;
automatically resizing the at least one dynamic information element based on the second size of the designated area.
